(19) United States
(12) Patent Application Publication
(10) Pub. No.: US 2009/0014492 A1
(43) Pub. Date: Jan. 15, 2009

(54) Device for the separative machining of components made from brittle material

(76) Inventor: Michael Haase, Grunenplan (DE)

Correspondence Address: SHLESINGER, ARKWRIGHT & GARVEY LLP, 1420 KING STREET, SUITE 600, ALEXANDRIA, VA, 22314, US

(21) Appl. No.: 12/216,178

(22) Filed: Jun. 30, 2008

Related U.S. Application Data
(63) Continuation of application No. PCT/EP2006/011714, filed on Dec. 6, 2006.

(30) Foreign Application Priority Data
Dec. 29, 2005 (DE) 10 2005 063 046.4
Apr. 21, 2006 (DE) 10 2006 018 622.2

(51) Int. Cl. C03B 33/09; B23K 26/40

(52) U.S. Cl. 225/93.5

(57) ABSTRACT

Device for severing components made from brittle material, for example, glass, ceramics, glass ceramics, by producing a thermally-induced stress fracture on component in a separation zone includes a laser for directing a laser beam onto component to be machined so that component partly transmits laser beam with partial absorption at least twice simultaneously or serially along separation zone at the same point or closely spaced points. Device includes a bearing surface on which component being machined is received, and device for subjecting component to mechanical stresses for promoting thermally induced stress fracture. Bearing surface has at least two bearing surface sections movable relative to each other between a first position and a second position, and component, in the first position, being supported in a manner substantially free from mechanical stresses, and, in a second position, component being subjected to mechanical stresses for promoting the thermally induced stress fracture.

### CROSS-REFERENCE TO RELATED APPLICATIONS

This application is a continuation of application no. PCT/EP2006/011714, filed Dec. 6, 2006, which claims the priority of German application no. 10 2006 018 622.2, filed Apr. 21, 2006, and which application no. PCT/EP2006/011714, filed Dec. 6, 2006, claims the priority of German application no. 10 2005 063 046.4, filed Dec. 29, 2005, and each of which is incorporated herein by reference.

### FIELD OF THE INVENTION

The invention relates to a device for the separative machining of components made from brittle material, such as for example glass, ceramics, and glass ceramics, by generating a thermally induced stress crack on the component in a separation zone. More particularly, the invention relates to a device for the separative machining of components made from brittle material, by generating a thermally induced stress crack on the component in a separation zone, and which device includes a laser for directing a laser beam onto a component to be machined.

### BACKGROUND OF THE INVENTION

Devices for machining components made from brittle material are for example known from DE 197 15 537 A1, DE 196 16 327 A1, WO 98/00266, DE 44 05 203 A1, WO 93/20015, DE 43 05 106, EP 0 448 168 A, JP 2000 281373 A, Patent Abstracts of Japan, publication number 10244386 A, the article “Cutting Sheet Glass with the Beam of a Solid-State Laser” by Shepelov et al. (Welding International, welding Institute, Abbington, GB, volume 14, No. 12, December 2000 (2000-12) P. 988-991, XP000998828, ISSN: 0950-07116), WO 2005/115678 A1 and WO 2005/107998 A1.

From WO 02/48059 A1 a device of this described type is known for the separative machining of components made from brittle material, such as for example glass, ceramics, glass ceramics or the like, by generating a thermally induced stress crack on the component in a separation zone, such device comprising a laser for directing a laser beam onto the component to be machined, such that the component partially transmits the laser beam with partial absorption at least twice simultaneously or serially along the separation zone substantially at the same point or at points with little distance to each other. To mount the component during machining the known device is provided with a bearing surface. The device known from the publication is further provided with means to supply the component with mechanical stresses to expedite the thermally induced stress crack.

A similar device is also known from DE 102 06 920 A1, with nothing being stated in the publication about the supply of the component to be separated with mechanical stresses to expedite the thermally induced stress crack.

A breaking device for separating ceramic printed circuit boards along weakened lines is known from DE 103 11 693 B3. However, the device known from the publication is not suited for the separative machining of components made from brittle material by generating a thermally induced stress crack at the component.

### OBJECTS AND SUMMARY OF THE INVENTION

It is an object of the invention to provide a device for the separative machining of components made from brittle material, such as for example glass, ceramics, and glass ceramics, by generating a thermally induced stress crack on the component in a separation zone, and with the operating speed and the quality of the separating edges formed during the separation of the component being increased.

This object is achieved by the device according to the invention for the separative machining of a component made from brittle material, and which device includes:

a) a device configured for generating a thermally induced stress crack on the component in a separation zone in the component;

b) the device for generating a thermally induced stress crack includes a laser for directing a laser beam onto a component to be machined, such that the component partially transmits the laser beam with partial absorption at least twice along the separation zone substantially at the same point;

c) a bearing surface provided, and the bearing surface being configure for mounting the component during machining;

d) a device configured for supplying the component to be machined with mechanical stresses to expedite the thermally induced stress crack;

e) the bearing surface includes at least two bearing surface sections, and the surface sections being movable relative to one another between a first position and the second position;

f) in the first position the component being mounted substantially free of mechanical stresses; and

g) in the second position the component being supplied with mechanical stresses to expedite the thermally induced stress crack.

A fundamental idea of invention is that a bearing surface with at least two bearing surface sections is provided that can be moved relative to each other. In a first position of the bearing surface sections relative to each other the component is mounted on the bearing surface essentially (i.e., substantially) free of mechanical stresses. According to the invention mechanical stresses in this sense are to be understood as mechanical stresses generated by an element or device configured for supplying (i.e., providing) the component with mechanical stresses, however not other mechanical stresses caused for example by the component's own weight. On the other hand, in the second position of the bearing surface sections relative to each other the component is supplied with mechanical stresses generated by the device for supplying the component with mechanical stresses to expedite the thermally induced stress crack. By appropriately controlling or adjusting the position of the bearing surface sections relative to each other, the extent to which the component is supplied with mechanical stresses to expedite the thermally induced stress crack can be controlled or adjusted this way with a high degree of precision. Thus, according to the invention, a defined superimposition of the stresses thermally induced by means of the laser radiation with mechanical stresses occurs. Surprisingly, it turned out that this way the machining speed can be significantly increased during the separation of components, and that the quality of the separating edges formed during the separation of a component is considerably improved. Moreover, the spreading of the thermally induced stress crack, in particular as regards its direction, can also be precisely controlled and adjusted. Thus, in the end, the device according to the invention makes it possible to introduce mechanical stresses into the component with a particular high degree of precision.

As a matter of principle, generating a thermally induced stress crack is based on the fact that brittle material breaks when adequately heated, for example through laser radiation, and subsequently cooled correspondingly. Incidentally, generating a thermally induced stress crack is generally known to experts, and thus will not be explained in detail here. In this connection reference is made to WO 02/48059 A1, which is incorporated herein by reference.

An advantageous further embodiment of the teachings according to the invention provides that the bearing surface sections in the first position are substantially situated in a common plane and in a second position in different planes at least in sections. This embodiment is especially well suited to machining substantially flat components, for example plane glass panes.

In principle, it is possible according to the invention to form the bearing surface sections at a common bearing surface, for example a bearing surface that consists of flexible material. In particular it is possible according to the invention to use a reflector made from flexible material, on which the component lies. In order to introduce mechanical stresses the component may, for example, be supplied with mechanical stresses by attaching a pressurization element on the side of the component that faces away from the reflector. The pressurization causes the component and the flexible reflector to bend, moving the bearing surface sections positioned on both sides of the bending line into the second position, in which the component is supplied with mechanical stresses. In order to make possible an especially precise supply of the component with mechanical stresses comprising a simple and cost-effective configuration, a different further development of the invention provides that the bearing surface sections are each formed at a bearing element.

A further development of the aforementioned embodiment provides that at least one gap is formed between the bearing elements at which the laser beam is directed during machining, and that the device to supply the component with mechanical stresses be embodied such that the mechanical stresses have an effect on the component in the area of the crack. Comprising a simple and relatively cost-effective configuration this embodiment makes possible an especially precise provision of the component with mechanical stresses, with the option of having a reflector arranged in the gap, such reflector reflecting the laser beam emitted by the laser.

In principle, according to the invention the component may be provided with mechanical stresses of any suitable kind, for example tensile stresses, provided such stresses expedite the machining or the separation process respectively. An extraordinarily advantageous further development of the teaching according to the invention provides that the device to supply the component with mechanical stresses be designed to supply the component with mechanical bending stresses. In this embodiment the device according to the invention may be configured especially simply and thus cost-effective. An additional advantage of supplying the component with bending stresses is that an especially high degree of precision is made possible in terms of achieving a desired stress distribution in the component.

Another advantageous further development of the invention provides that a maximum of stress distribution achieved in the component by supplying the component with mechanical stresses is located in the area of the gap. This way, the maximum effect of the mechanical stresses takes place in the separation zone, which—in this embodiment—is also located in the area or region of the gap.

According to the invention, the device for supplying the component with mechanical stresses may be configured in any suitable way. In order to configure the assembly of the device according to the invention especially simply and thus cost-effectively, an advantageous further development of the invention provides that at least one of the bearing elements can be moved vertically relative to the surface of the component, such that the device to supply the component with mechanical stresses is at least in part formed by the bearing element or the bearing elements respectively. In this embodiment the bearing elements serve not only for mounting purposes, but also to supply the component with mechanical stresses. For this, the bearing elements can be moved relative to one another.

A further development of the aforementioned embodiment provides that at least one of the bearing elements be adjustable along a linear displacement axis, in particular in vertical direction. This embodiment results in an especially simple configuration of the device according to the invention.

An additional further development of the embodiment, in which at least one of the bearing elements can be moved, provides that at least one of the bearing elements can be swiveled around a preferably substantially horizontal swiveling axis, owing to the swiveling mounting of at least one of the bearing elements the component can be supplied especially evenly and precisely with mechanical stresses, especially bending stresses.

In order to arrange the provision of mechanical stresses even more evenly and precisely in the aforementioned embodiment, a further development of this embodiment provides that at least two bearing elements can be swiveled in opposite direction relative to each other around preferably substantially parallel swiveling axes.

In the aforementioned embodiments the device to supply the component with mechanical stresses is formed—completely or in part—by the bearing elements or by one of the bearing elements. It is however also possible according to the invention to provide a separate configuration in order to supply the component with mechanical stresses, so that the only purpose of the bearing elements then is to mount the component. For this, a further development of the invention provides that the device to supply the component with mechanical stresses comprise at least one supply element that can be brought in contact with the component to supply such component.

In principle it is possible in the aforementioned embodiment to arrange the supply element on the same side of the component as the laser. It is for example possible to use a supply element that is comprised of a material highly transmissive for the laser radiation of the wavelength used and that is arranged in the laser's beam projection. This way, the supply element supplies the component with mechanical stresses directly in the laser's sphere of influence (or operative region), namely in the separation zone. In order to arrange the configuration of the device according to the invention in a simple and thus cost-effective way in the embodiments comprising the supply element, a further development provides for the supply element to be arranged on the side of the component that faces away from the laser.

According to the invention, any number of supply elements can be used.

Another further development of the embodiment comprising the supply element provides for the supply element to be arranged inside the gap.

In principle, the supply element can be designed in any manner suitable to supply the component with mechanical stresses. In order to arrange the supply element in an especially simple way, an advantageous further development of the teaching according to the invention provides that the supply element is designed as a pressure element to pressurize the component. The pressurization of the component according to the invention may serve especially to generate bending stresses in the component.

A further development of the aforementioned embodiment provides for the supply element to be configured as a wheel rolling off on the component. In this embodiment pressurization of the component is made possible in a simple way without generating excessively strong friction between the pressurization element and the component.

A further development of the aforementioned embodiment provides that the wheel follows the laser beam in moving direction along the separation zone. In this embodiment the mechanical stresses are being generated in the area, where the material of the component cools off following radiation with the laser beam and where the thermally induced stress crack thus occurs. This way, the thermally induced and mechanical stresses work at the same location of the separation zone.

Relative terms such as up, down, left, and right, are for convenience only and are not intended to be limiting.

The invention is explained in detail below based on the attached, schematic drawing, in which embodiments of a device according to the invention are illustrated.

### BRIEF DESCRIPTION OF THE DRAWINGS

FIG. 1 is a perspective side view of a first embodiment of a device according to the invention in a state in which the component is not supplied with mechanical stresses;

FIG. 2 shows, in the same manner as FIG. 1, the embodiment of FIG. 1 in a state in which the component is supplied with mechanical stresses;

FIG. 3 shows, in the same manner as FIG. 2, a second embodiment of a device according to the invention;

FIG. 4 shows, in the same manner as FIG. 2, a third embodiment of a device according to the invention;

FIG. 5 shows, in the same manner as FIG. 2, a fourth embodiment of a device according to the invention;

FIG. 6 shows, in the same manner as FIG. 2, a fifth embodiment of a device according to the invention;

FIG. 7 is a side view of the device of FIG. 6; and

FIG. 8 shows, in the same manner as FIG. 2, a sixth embodiment of a device according to the invention.

### DETAILED DESCRIPTION OF THE INVENTION

In the Figs. the same or corresponding components are marked with the same reference numeral.

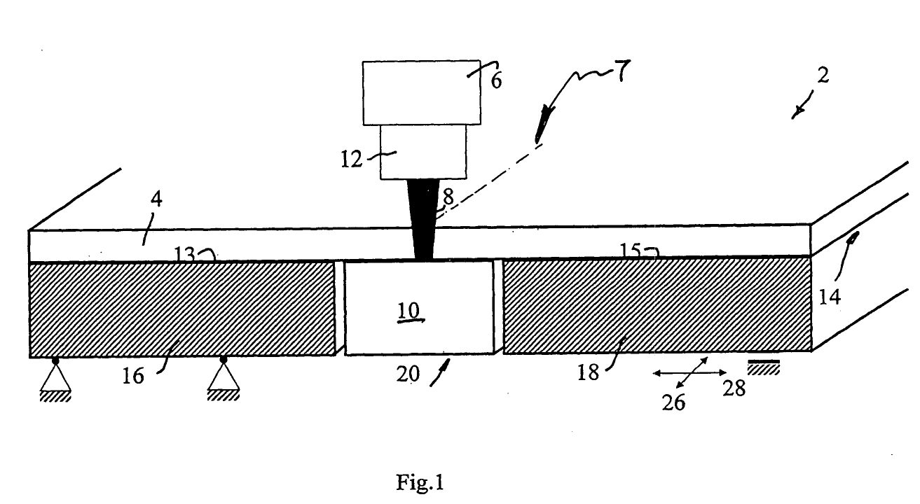

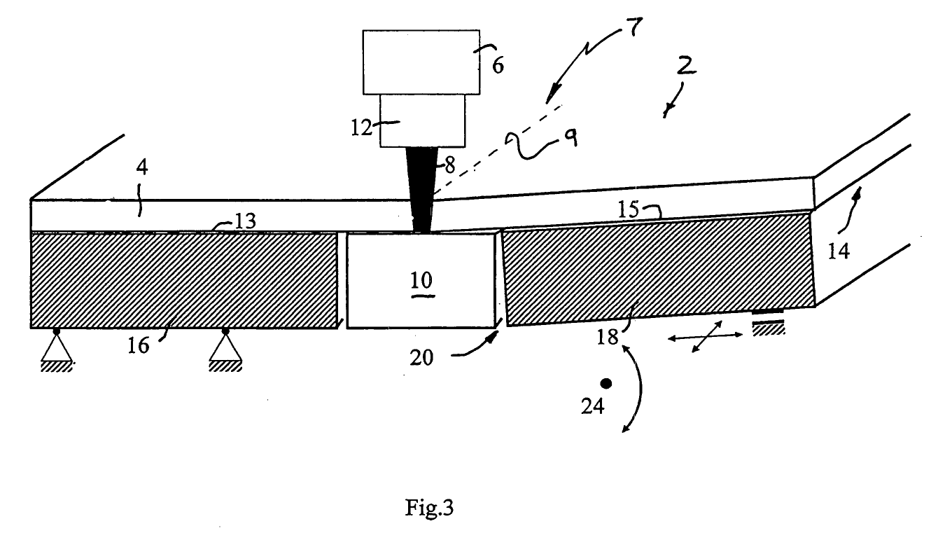

FIG. 1 shows a first embodiment of a device 2 according to the invention for the separative machining of components made from brittle material, such as for example glass, ceramics, glass ceramics, or the like, by generating a thermally induced stress crack on the component in a separation zone. In this embodiment the device 2 serves to sever a component 4 formed by a glass pane. The device 2 comprises a laser 6 for directing a laser beam 8 onto the component to be machined, such that the component partially transmits the laser beam 8 with partial absorption at least twice simultaneously or serially along a separation zone 7, in which the thermally induced stress crack 9 forms, substantially at the same point or at points with little distance relative to each other. For this purpose, the device 2 comprises a first reflector 10 arranged at the side facing away from the laser 6, and a second reflector 12 arranged on the side of the laser 6. During the operation of the device 2 the laser beam 8 is reflected back and forth between the reflectors 10, 12, so that the component transmits the laser beam 8 repeatedly with partial absorption. With respect to the type of repeated transmission of the laser beam 8, reference is made to WO 02/48059, in particular to FIG. 3 of the document. To mount the component 4 the device 2 comprises a bearing surface 14, formed at two plane bearing elements 16, 18 in this embodiment according to the invention, such bearing elements 16, 18 each comprising a bearing surface section 13, 15 and forming a gap 20 between them, with a first reflector 10 arranged in said gap 20, as is apparent from FIG. 1. Thus, in this embodiment the laser beam 8 is directed at gap 20 between the bearing elements 16, 18.

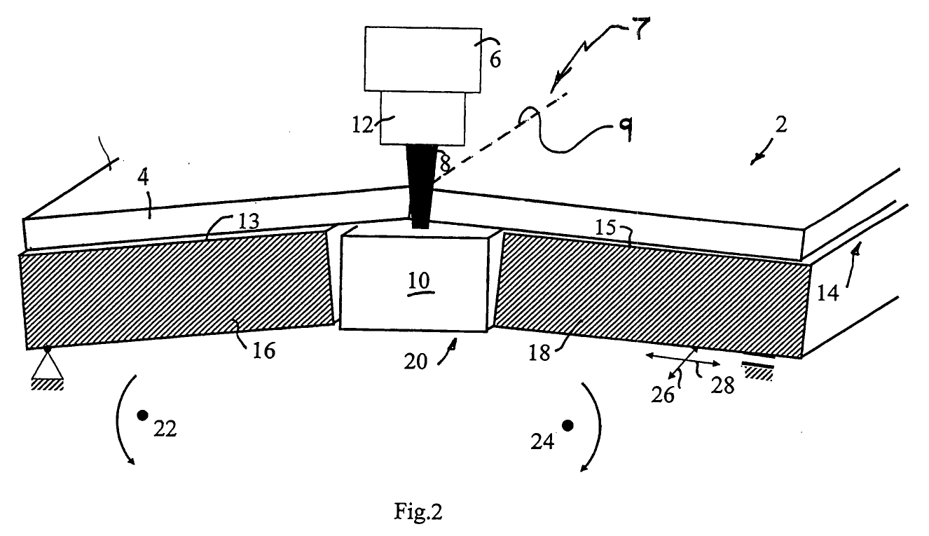

A device for supplying the component 4 with mechanical stresses provided according to the invention is configured by the bearing elements 16, 18 in this embodiment, as is explained in detail below based on FIG. 2.

FIG. 2 shows the device 2 pursuant to FIG. 1 in a state in which the component 4 is supplied with mechanical stresses, namely bending stresses, such bending stresses being superimposed on the thermally induced stresses, generated through radiation with the laser beam 8 in the component 4. In this embodiment the device to supply the component 4 with mechanical stresses are formed by the bearing elements 16, 18, the latter being able to be moved relative to one another and vertically to the surface of the component 4, namely swiveled in opposite direction around swiveling axes 22, 24 that are parallel relative to each other. As indicated in FIG. 2, the component 4 is bent when the bearing elements 16, 18 are swiveled in opposite direction, so that mechanical bending stresses form in the separation zone located above the gap 20, such bending stresses being superimposed on the thermally induced stresses generated by means of the laser beam 8. In the illustrated embodiment the maximum stress distribution achieved by supplying the component 4 with mechanical stresses in component 4 is located in the area of the gap 20. As a result of the mechanical bending stress the spreading of the thermally induced stress crack generated by means of the laser beam 8 is expedited and significantly accelerated.

If necessary, at least one of the bearing elements 16, 18—the bearing element 18 in the embodiment illustrated in FIG. 1 and FIG. 2—may be movable parallel to the surface of the component 4, as indicated by arrows 26, 28 in FIG. 1. This way a “floating” mounting of the bearing element 18 is achieved.

FIG. 3 illustrates a second embodiment of a device 2 according to the invention that differs from the embodiment pursuant to FIG. 1 in that only the bearing element 18 can be swiveled around a swiveling axis 24, while the bearing element 16 is configured in a stationary position.

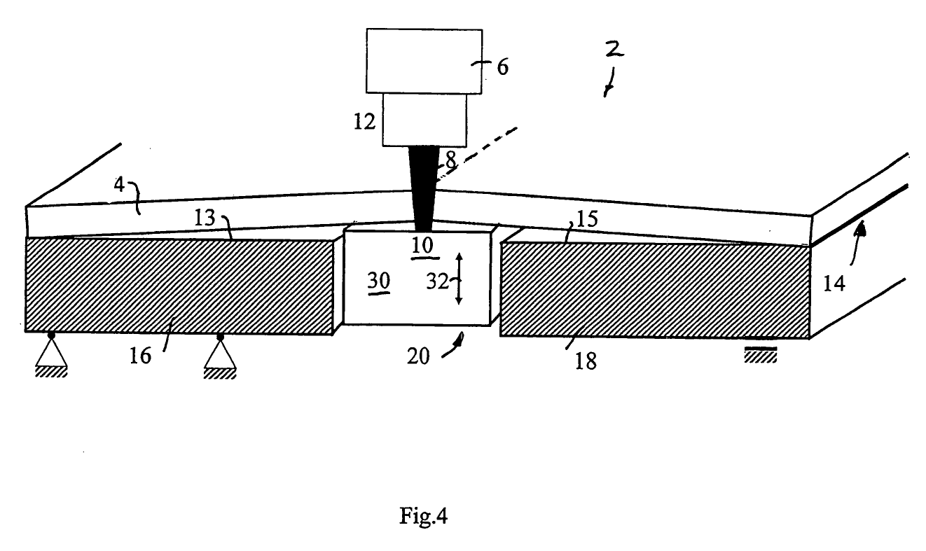

FIG. 4 shows a third embodiment of a device 2 according to the invention that differs from the embodiment illustrated in FIG. 1 in that the device to supply the component 4 with mechanical stresses are not formed by the bearing elements 16, 18, but rather that a separate supply element 30 is provided, at whose side facing the component 4 the first reflector 10 is formed. To supply the component 4 with mechanical stresses the supply element 30 can be brought in contact with such component 4, with said supply element 30 being adjustable in vertical direction in the illustrated embodiment for this purpose, as indicated by an arrow 32 in FIG. 4. To supply the component 4 with mechanical stresses the supply element 30 is brought in contact with the component 4 and exerts a compressive force on the component 4, so that bending stresses form in said component 4.

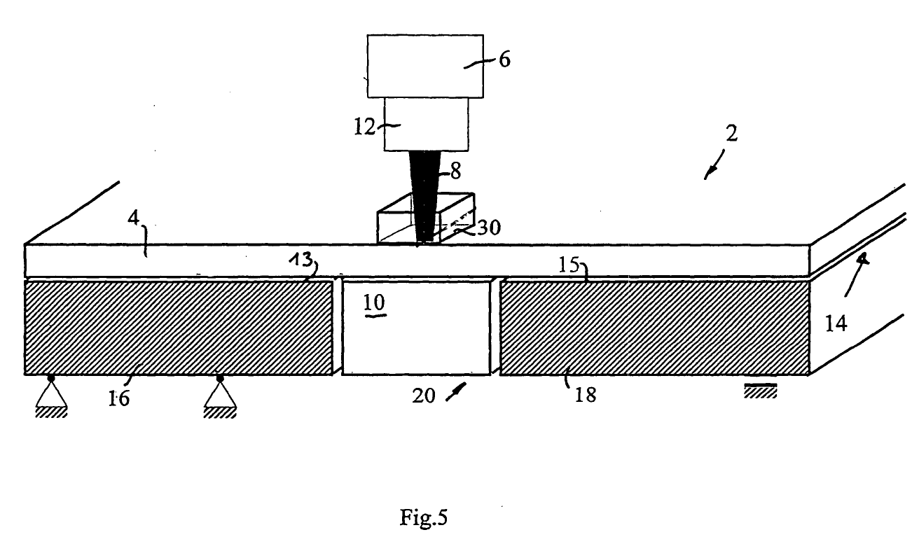

FIG. 5 shows a fourth embodiment of a device 2 according to the invention that differs from the embodiment pursuant to FIG. 4 in that the supply element 30 is arranged on the same side of the component 4 as the laser 6. In this embodiment the supply element 20 consists of a material highly transmissive for the laser radiation of the used wavelength and is penetrated by the laser beam 8, as shown in FIG. 5.

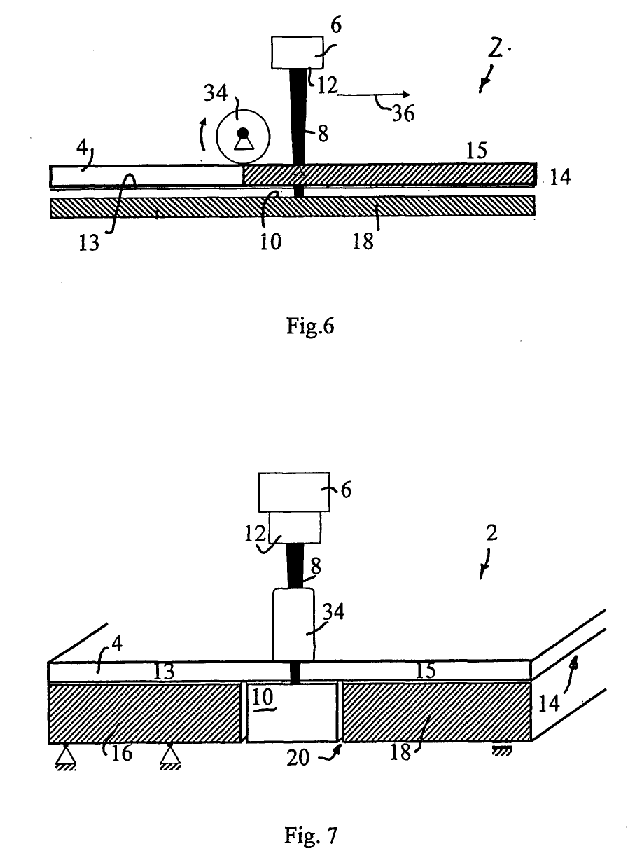

FIG. 6 shows a fifth embodiment of a device 2 according to the invention that differs from the embodiment pursuant to FIG. 5 in that the supply element is formed by a wheel 34 rolling off on the component 4.

As is apparent from FIG. 7, the wheel 34 follows the laser beam 8 in its moving direction along the separation zone indicated by arrow 36 in FIG. 7.

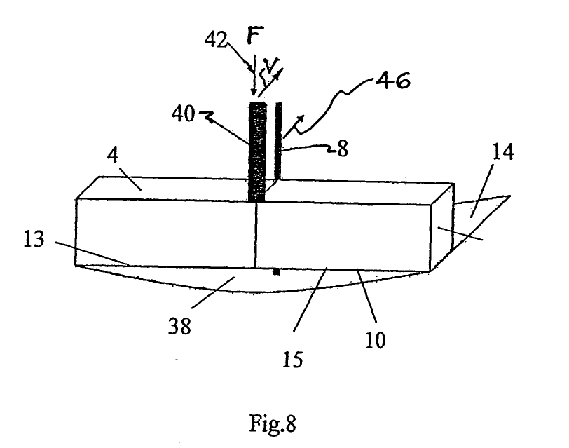

FIG. 8 shows a sixth embodiment of a device 2 according to the invention that differs from the embodiments illustrated in FIG. 1 through 7 in that the bearing surface 14 is not formed at two bearing elements, but at one single bearing element 38. The bearing element 38 is made from ductile material, for example an elastomer with a suitable module of elasticity. The bearing element 38 carries the reflector 10 on its surface facing the component 4, such reflector 10 being designed film-like and glued on the bearing element 38 in this embodiment. The reflector 10 thus forms the bearing surface 14. The embodiment depicted in FIG. 8 further shows a rod-like configured pressurization element 40, through which the component 4 is supplied with compressive force. The mode of operation of the embodiment illustrated in FIG. 8 is as follows:

To superimpose the thermally induced stresses generated by means of the laser not depicted in FIG. 8 with mechanical stresses, the pressurization element 40 exercises a compressive force F on the component 4 acting in the direction of an arrow 42, based on which compressive force the component 4 bends along with the bearing element 38 and the reflector 10. This way, mechanical stresses are being introduced into the component 4. In this connection, the compressive force exercised by the pressurization element 40 is selected such that it expedites the formation of a thermally induced stress crack in a defined way. For clarity, laser beam 8 is shown, and other parts of laser 6 are omitted in FIG. 8. An arrow 46 shows the direction in which the device may be moved at a velocity V relative to component 4, in use.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

What is claimed is:

1. Device for the separative machining of a component made from brittle material, comprising:
a) a device configured for generating a thermally induced stress crack on the component in a separation zone in the component;
b) the device for generating a thermally induced stress crack includes a laser for directing a laser beam onto a component to be machined, such that the component partially transmits the laser beam with partial absorption at least twice along the separation zone substantially at the same point;
c) a bearing surface provided, and the bearing surface being configure for mounting the component during machining;
d) a device configured for supplying the component to be machined with mechanical stresses to expedite the thermally induced stress crack;
e) the bearing surface includes at least two bearing surface sections, and the surface sections being movable relative to one another between a first position and the second position;
f) in the first position the component being mounted substantially free of mechanical stresses; and
g) in the second position the component being supplied with mechanical stresses to expedite the thermally induced stress crack.

2. Device according to claim 1, wherein:
a) in the first position the bearing surface sections are substantially located in a common plane; and
b) in the second position the bearing surface sections are substantially located in different planes.

3. Device according to claim 1, wherein:
a) each of the bearing surface sections includes a bearing element.

4. Device according to claim 3, wherein:
a) at least one gap is formed between the bearing elements;
b) the laser beam is directed at the gap during machining; and
c) the device configured for supplying the component to be machined with mechanical stresses is configured for causing the mechanical stresses to affect the component in a region of the gap.

5. Device according to according to claim 1, wherein:
a) the device configured for supplying the component to be machined with mechanical stresses is configured for causing mechanical bending stresses.

6. Device according to claim 4, wherein:
a) the device configured for supplying the component to be machined with mechanical stresses in a region of the gap is located in the region of the gap for causing a maximum of stress distribution in the component.

7. Device according to claim 3, wherein:
a) at least one of the bearing elements is movable vertically relative to the surface of the component, such that the device for supplying the component with mechanical stresses is configured at least in part by the bearing elements.

8. Device according to claim 7, wherein:
a) at least one of the bearing elements is adjustable along a linear displacement axis.

9. Device according to claim 7, wherein:
a) at least one of the bearing elements can be swiveled around a substantially horizontal swiveling axis.

10. Device according to claim 9, wherein:
a) at least two bearing elements can be swiveled in opposite directions relative to each other around respective substantially parallel swiveling axes.

11. Device according to claim 1, wherein:
a) the device configured for supplying the component to be machined with mechanical stresses includes a supply element which can be brought in contact with the component for supplying the component with mechanical stresses.

12. Device according to claim 11, wherein:
a) the supply element is arranged on a side of the component that faces away from the laser.

13. Device according to claim 12, wherein:
a) the supply element is arranged in the gap.

14. Device according to claim 11, wherein:
a) the supply element is configured as a pressure element for the pressurization of the component.

15. Device according to claim 11, wherein:
a) the supply element is configured as a wheel rollable on the component.

16. Device according to claim 15, wherein:
a) the wheel is configured for following the laser beam in a direction of movement along the separation zone.

17. Device according to claim 1, wherein:
a) the partially transmitting the laser beam with partial absorption at least twice along the separation zone includes at least one of simultaneously and serially along the separation zone.

18. Device according to claim 1, wherein:
a) the device configured for generating a thermally induced stress crack on the component made from brittle material is configured for generating a stress crack on the brittle material including one of glass, ceramics, and glass ceramics.
